(19) United States
(12) Patent Application Publication
(10) Pub. No.: US 2011/0222311 A1
(43) Pub. Date: Sep. 15, 2011

(54) Web Converting Methods for Forming Light Guides and the Light Guides Formed Therefrom

(76) Inventor: Brian A. Kinder, Woodbury, MN (US)

(21) Appl. No.: 13/130,506

(22) PCT Filed: Nov. 23, 2009
(86) PCT No.: PCT/US09/65512

§ 371 Date: May 20, 2011

Related U.S. Application Data
(60) Provisional application No. 61/117,389, filed on Nov. 24, 2008.

(51) Int. Cl. F21V 7/22; G02B 6/26; B31B 1/14

(52) U.S. Cl. 362/611; 385/38; 493/340

(57) ABSTRACT

A method of forming a light guide, web structures and light guide structures are described herein. The method includes cutting a web to provide film pieces, where a first major surface of each film piece is capable of emitting light when light is injected into the film piece from a first cut edge of the film piece. The step of cutting produces structures on the first edge of the film.

### FIELD OF THE INVENTION

This invention generally relates to light guides and displays incorporating same. In particular, the invention relates to flexible light guides.

### SUMMARY OF THE INVENTION

Generally, the present invention relates to light guides. The present invention also relates to displays incorporating light guides.

In one embodiment, a method of forming a light guide includes providing a web of a film having a major surface and a web edge and cutting the web to provide film pieces, wherein each film piece has a first major surface, a second major surface and at least a first cut edge. The first major surface of each film piece is capable of emitting light when light is injected into the film piece from the first cut edge of the film piece. The major surface of each film piece is capable of emitting at least a majority of the light injected into the film piece from the first cut edge. The step of cutting produces structures on the first edge of the film.

In another embodiment a method of forming a light guide includes providing a web of a film having a major surface and a web edge, where the major surface of the film comprises a plurality of light extractors capable of extracting light propagating in the web. Another step is cutting the web using a rotary razor blade to provide film pieces, wherein each film piece has a first major surface, a second major surface and at least a first cut edge. The first major surface of each film piece is capable of emitting light when light is injected into the film piece from the first cut edge of the film piece. The major surface of each film piece is capable of emitting at least a majority of the light injected into the film piece from the first cut edge. The step of cutting produces parallel groove structures on the first edge of the film.

In another embodiment, an intermediate product formed during the process of forming a light guide includes a web of a film having a first major surface, a second major surface, and a first edge, where the first edge includes structures. The first major surface of the light guide is capable of emitting light when light is injected into the first edge of the web, and the first major surface is capable of emitting at least a majority of the light injected into the launch edge.

In another embodiment, an intermediate product formed during the process of forming a light guide includes a web of a film including a first flexible layer and a second flexible layer. The web further includes a first major surface of the first flexible layer, a second major surface of the second flexible layer, a plurality of light extractors capable of extracting light propagating in the light guide on the first major surface, and a first edge, wherein the first edge includes structures. The first major surface of the light guide is capable of emitting light when light is injected into the first edge of the web, and the first major surface is capable of emitting at least a majority of the light injected into the launch edge.

In yet another embodiment, a light guide includes a first flexible layer having a first major surface, a second flexible layer having a second major surface, and a launch edge having a launch edge surface, where the launch edge surface comprises structures. The first major surface of the light guide is capable of emitting light when light is injected into the light guide from the launch edge. The first major surface is capable of emitting at least a majority of the light injected into the launch edge. The light guide includes a first region where thickness does not vary substantially and a second region adjacent the edge of the light guide where the thickness of the light guide varies at a first rate.

### BRIEF DESCRIPTION OF DRAWINGS

The invention may be more completely understood and appreciated in consideration of the following detailed description of various embodiments of the invention in connection with the accompanying drawings, in which:

FIG. 1 is a schematic top-view of a back light system.

FIG. 2 is a schematic top-view of a second back light system.

FIG. 3 is a schematic top-view of a third back light system.

FIG. 4 is a schematic top view of a repeating pattern of film light guides.

FIG. 5 is a schematic side view of a back light system.

FIG. 6 is a schematic side view of another back light system.

FIG. 7 is a schematic side view of one embodiment of a light guide having an input edge structure.

FIG. 8 is a schematic side profile of the example light guide of FIG. 7.

FIG. 9 is a photograph of an input edge structure of one example of a light guide of the technology disclosed here.

FIG. 10 is a schematic side view of a process step consistent with one embodiment of the technology disclosed herein.

FIG. 11 is a schematic cross-sectional view of a process step using a rotary razor blade consistent with one embodiment of the technology disclosed herein.

FIG. 12 is a front view of a rotary razor blade having serrations.

FIG. 13 is a schematic side view of a process step consistent with one embodiment of the technology disclosed herein.

FIG. 14 is a schematic side view of another process step consistent with one embodiment of the technology disclosed herein.

FIG. 15 is an alternative side profile of an example light guide consistent with one embodiment of the technology disclosed herein.

FIG. 16 is a side view of a process step consistent with one embodiment of the technology disclosed herein.

FIG. 17 is a photograph of an input edge structure consistent with the technology disclosed herein.

FIG. 18 is a cross-sectional view of a serrated rotary razor edge, taken along line 18-18 of FIG. 12, according to one embodiment.

FIG. 19 is a cross-sectional view of another serrated rotary razor edge, according to one embodiment.

FIG. 20 is a schematic side view of a backlight system having an input edge coupler according to one embodiment.

### DETAILED DESCRIPTION

The present invention generally applies to back lights that incorporate a light guide for providing a desired illumination in a display system. The invention particularly applies to thin flexible light guides that can be easily and economically manufactured. Such thin flexible light guides are described in co-owned, co-pending U.S. Published Patent Application 2007-0279935, titled FLEXIBLE LIGHT GUIDE, which is hereby incorporated herein in its entirety. Light guides are used in display systems, general lighting, commercial signage and many other applications.

Conventionally, light guides have been made using injection molding techniques. Features are generally generated as negatives of features in a mold cavity. The resolution of a feature is limited primarily by the mold. Examples of light guide features include extractors that bring light out of the guide in a prescribed manner, tabs along the edge for alignment with additional components, and coupling features to increase that amount of injected light. In the case where the light guide is illuminated by LEDs, as found in most cell phones, additional features are located on the launch edge of the guide. Such features are referred to as “input edge structures” or IES.

IES are generally created in the injection molding process and are positioned on the edge directly exposed to the light source. IES have the primary function of controlling the angle of light entering the guide so that it can then by extracted uniformly over the active area of the LCD panel. LEDs are discrete and typically do not illuminate the entire length of the edge of the light guide evenly. As a result, a mixing region is designed into the guide between the edge and viewing area. This mixing region allows space for the fields from individual LEDs to overlap, producing a more even distribution of light prior to reaching the viewing area and increasing the uniformity of the display. Typical IES found on injection molded guides include precise geometric features such as prisms, trapezoids, sinusoids, or a mixture of flat regions and such features, and are located on the edge proximal to the LEDs, which is referred to as the launch edge of the light guide. The geometry and other such properties of the IES must be accounted for in the optical design of the light guide for optimum uniformity and efficiency.

Additionally, the angular spreading power of the IES also can reduce the number of LEDs required to illuminate the display reducing the cost of the module. They can also shorten the mixing region making the display more compact or enable the use of a larger display. Examples of both advantages are depicted across FIGS. 1-3. Also, by rapidly spreading and mixing the injected light, such IES features may also allow light guide designs that are less sensitive to LED alignment, thereby reducing non-uniformity of the extracted light.

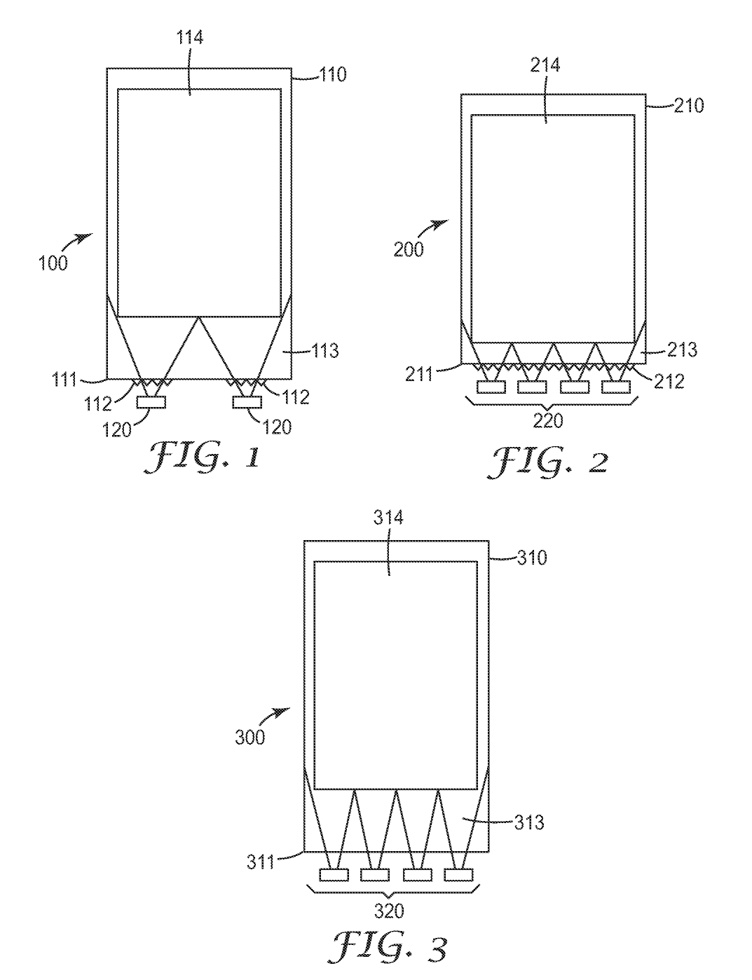

FIGS. 1-3 depict three varying schematic top views of back light systems. FIG. 1 depicts a back light system 100 that includes a film 110 having a launch edge 111 that defines two IES regions 112. The film further defines a mixing region 113, and an extractor area 114. The back light system 100 also includes two LEDs 120 positioned proximate to the launch edge 111 of the film 110. In FIG. 2, four LEDs 220 are used and an IES region 212 expands across a substantial portion of a launch edge 212, which allows shortening of a mixing region 213. The back light system 300 depicted in FIG. 3 does not include an IES region across any portion of a launch edge 312, and so a full size mixing region 313 is needed despite the four LEDs 320 that are used.

As mentioned above, an IES is typically found on conventional injection molded light guides. Instead of injection molded techniques it is possible to make a light guide, which is hereinafter referred to as a flexible light guide (FLG), with continuous manufacturing methods. A FLG is made on a continuous web and is then converted into individual parts in several process steps. For example, U.S. Published Patent Application 2007-0279935, which was previously incorporated herein, discloses a multilayer thin and flexible light guide for use in a backlight. The flexible light guide described therein includes a first layer and a second layer, and can be fabricated using a continuous roll to roll process, such as a continuous cast and cure process.

Like conventional injection molded light guides, FLGs can benefit from an IES to spread light from each LED so that the active area of the display is uniformly illuminated and the mixing region is shortened.

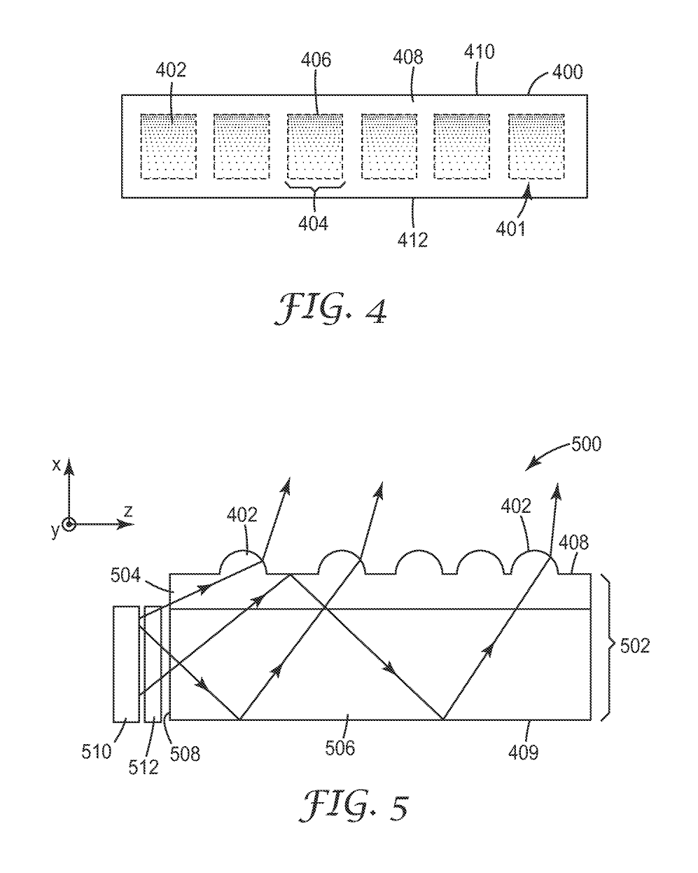

A schematic top view of repeating extractor patterns on a web for producing FLGs is depicted in FIG. 4. A web 400 defines multiple FLG regions 401, each having a pattern of extractors 402 and each shaped to serve as a light guide when it is removed from the web. The FLG regions 401 are defined around discrete sections of extractor patterns 402 in this embodiment, but in other embodiments a continuous extractor pattern could be present on the web 400. Further examples of extractor patterns and corresponding FLG outlines are shown in co-pending, commonly assigned U.S. Patent Application No. 61/117,382, titled “Light Guides with Flexible Extraction Pattern Layouts and Methods for Forming Light Guides”, filed on Nov. 24, 2009, which is hereby incorporated by reference in its entirety.

The extractors 402 are present on a first major surface 408 of the web, which is the surface facing the viewer in FIG. 4. The web includes two major edges, 410 and 412.

Individual light guides are produced when the web is cut along the broken lines forming the border of the FLG regions 401. Each of these film pieces includes a first major surface facing the viewer in FIG. 4 and a second major surface opposite from the first major surface. Each film piece can be used to form a light guide that is capable of emitting light through its first major surface when light is injected in the web from a launch edge 404. Generally the major surface of the film piece is capable of emitting at least a majority of the light injected into the web from the launch edge 404.

In some embodiments, the FLG regions contain a plurality of light extractors 402 in an extractor pattern on the first major surface in order to accomplish the extraction of the light through the first major surface. The extractors 402 are configured so as to control the emitted light through the major surface of the light guide so that it appears, to the eyes of a viewer, to be emitted in a predetermined pattern, such as a substantially even manner. For an even or uniform light distribution, light extractor density is decreased progressively towards the launch edge 404 side of each FLG region 401, because the light is generally brighter towards the launch edge 404 where the light is injected into the light guide, although there may exist local regions, such as corners and between LEDs, where higher densities of extractors are required. FIG. 5 is a side view of a backlight system 500 including a flexible light guide 502, which includes a first flexible layer 504, a second flexible layer 506, a first major surface 408 and a second major surface 409. Light extractors 402 are present on the first major surface 408. The backlight system 500 includes a light source 510 and an optical coupler 512.

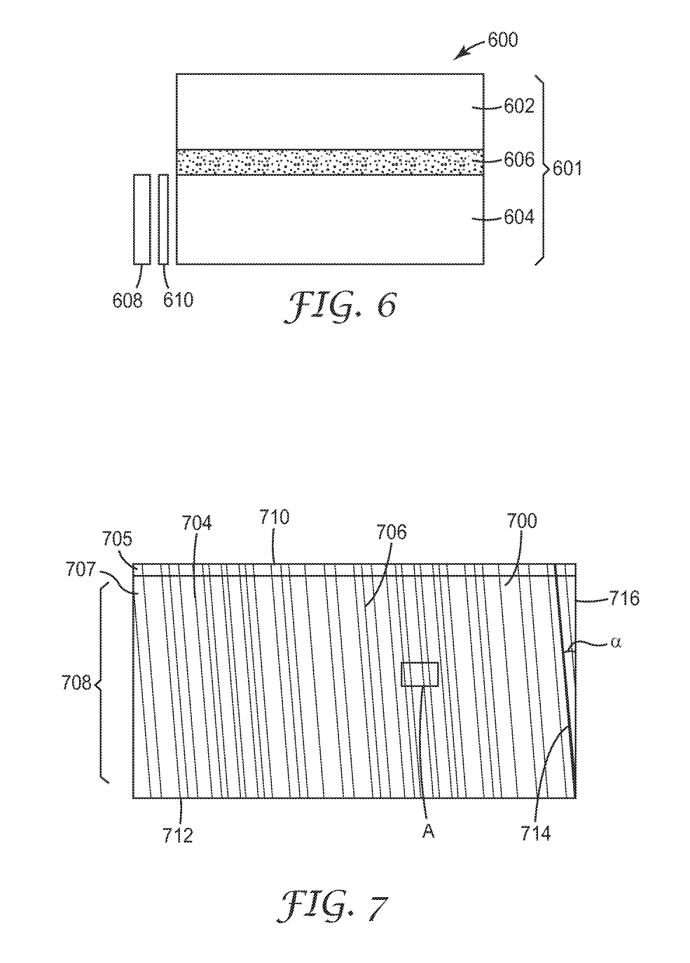

In some embodiments, a web made of two film layers having glossy surfaces (a gloss-gloss substrate) with diffuse particles disposed there between can be used in lieu of a light extractor pattern 402 to extract light through a first major surface. FIG. 6 is a schematic side view of a backlight 600 including such a light guide 601 including a first gloss layer 602, a second gloss layer 604, and diffuse particles 606 disposed there between. The backlight also includes a light source 608 and an optical coupler 610.

Referring back to the flexible light guide embodiment of FIG. 4, the web 400 can generally comprise any material known in the art that could be used for the purposes disclosed herein. For example, U.S. Published Patent Application 2007-0279935, previously incorporated herein, discloses a multilayer thin and flexible light guide for use in a backlight. The light guide includes a first layer and a second layer, and can be fabricated using a continuous roll to roll process, such as a continuous cast and cure process. Such a light guide can allow for reduced display thickness for a more compact result. In one embodiment the web 400 consists of a patterned UV curable resin on a polymer substrate on a polyester carrier liner. The polyester liner, in a particular embodiment, measures 40 to 90 μm. Examples of materials for the polymer substrate may be polycarbonate and polymethylaccrylate. Examples of the carrier liner material in addition to polyester include polyethylene, polypropylene and coated paper.

According to the embodiments disclosed herein, the FLG disclosed herein is not molded, and it relies on the converting method to generate the IES. The converting method has been found to be capable of generating structures on the launch edge of the film. The converting method has been found to be capable of creating structures that are substantially consistent, reproducible, and uniformly rough. Methods have been developed to convert the launch edge 404 of the FLG that exhibit the previously listed qualities. One preferred method uses a rotary razor blade that cuts the launch edge leaving a substantially perpendicular edge that is uniformly rough with mostly vertically aligned striations. FIG. 7 is a schematic view of a portion of a launch edge of a flexible light guide 700 created by a rotary razor blade method. The launch edge 704 includes an input edge structure that is created when the launch edge of the individual light guide pieces 700 is cut from a web of material. In the embodiment of FIG. 7, the input edge structure includes parallel grooves 706 that are irregularly spaced and are at an angle compared to a vertical line in the orientation of FIG. 7. The groove angle α is determined by measuring the angle between a line 714 substantially parallel to one or more grooves and a vertical line 716. In various embodiments, the groove angle α is at least 2 degrees, at least 5 degrees, at least 10 degrees, and at least 20 degrees. The grooves may have a more horizontal orientation as well, having groove angles of about 80 to 100 degrees, especially when a static razor method is used as will be further discussed herein. The particular embodiment of FIG. 7 includes a first flexible layer 705 and a second flexible layer 707, where the film has a first major surface 710 and a second major surface 712.

The structures 706 are formed in an IES region 708 of the launch edge 704, which is a mid-section of the launch edge 704. Due to the nature of cutting by rotary razor, the launch edge 704 is not completely planar adjacent to the top surface 710 and bottom surface 712 of the film in some embodiments. The IES region 708 is defined by the portion of the launch edge 704 having a substantially planar surface. The IES region 708 also possesses one or more substantially consistent surface qualities such as flatness, roughness, and/or consistent groove angle.

Within the IES region 708, the roughness, edge angle, and striation or groove angle can be determined. The roughness is measured from an area such as area A in FIG. 7 that is within an area that has one or more substantially consistent surface qualities. The roughness can be measured using a Keyence™ Confocal Microscope (a microscope distributed by Keyence Corporation, Osaka, Japan). The root mean square (RMS) roughness can be less than 10 micrometers, or less than 5 micrometers.

The edge angle is measured from a line parallel to the plane defined by the IES region 708 relative to the top surface of the film. The edge angle is discussed in more depth in reference to FIG. 8.

FIG. 8 is a side profile of an example light guide 700 consistent with the technology disclosed herein, and in particular the embodiment depicted in FIG. 7, where a rotary razor is used as the converting method to produce the launch edge 704 and define the IES region 708 from a web.

The IES region 708 has a height h. The height of the launch edge 704 is t. Generally, height h is about 70-85% of the total height t. In one embodiment, the height h is 80% of the total height t. In one embodiment, the height h is 75% of the total height t.

The edge angle e is measured from a line substantially parallel to the plane defined by the IES region 708 relative to the top surface 710. Such edge angle e generally ranges from about 80 degrees to about 100 degrees, or in some embodiments, 85 degrees to about 95 degrees. More specifically, in various embodiments, edge angles e range from about 87 degrees to about 93 degrees. In certain embodiments, the edge angle is 88 degrees to 92 degrees. In one embodiment, the edge angle is 90 degrees.

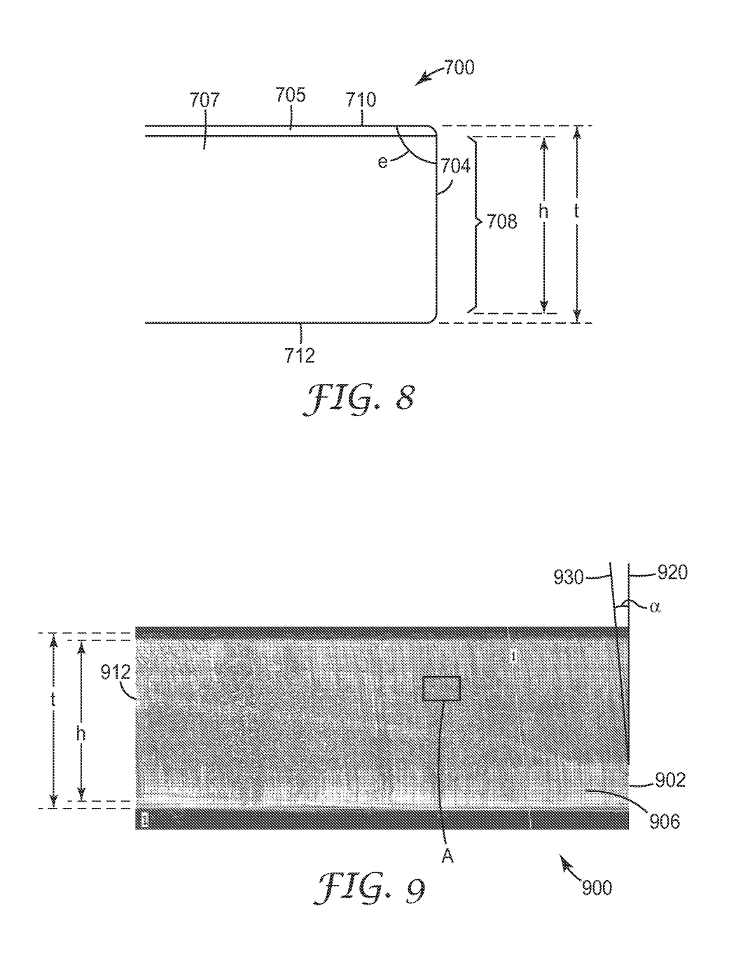

FIG. 9 is a photograph taken through a microscope of one example of a launch edge 902 of a light guide 900, at 200× magnification, where the launch edge 902 has IES 906 created by rotary razor cutting. The angle a of a representative parallel groove 930 with respect to a vertical line 920 is 7.38 degrees. Several samples of input edge structures similar to those shown in FIG. 9 were prepared using a rotary razor blade cutting method. Table 1 shows the results for edge angle, groove angle and RMS roughness for those samples.

Sample number 7 was cut using a stainless steel rotary razor blade without a coating. Sample number 6 was cut with a rotary razor blade having a blade coated with titanium nitride, and is shown in FIG. 9. The effects of coatings on the rotary razor blade will be further described herein.

TABLE 1

| | Edge | Groove | RMS Roughness |
|---|---|---|---|
| Sample No. | Angle | Angle | (micrometers) |
| 1 | 90.75 | 9.48 | 0.28 |
| 2 | 92.42 | 11.19 | 0.84 |
| 3 | 91.74 | 8.01 | 0.64 |
| 4 | 92.86 | 8.02 | 0.43 |
| 5 | 90.55 | 9.15 | 0.38 |
| 6 | 89.34 | 7.38 | 0.78 |
| 7 | 96.99 | 6.74 | 3.01 |
| Average | 91.66 | 9.17 | 0.514 |

The sample light guides performed well and the input edge structures increased the amount of light coupled into the light guides.

### Converting Methods

There are multiple converting methods that can be used consistent with the present technology. Generally such methods incorporate the use of a tool having a blade for cutting a film to produce a launch edge and create structures on the launch edge. In one particular embodiment a rotary razor blade is used as the converting method, but other technology known in the art can also be used. Other converting methods include, but are not limited to, die cutting, rotary die cutting, steel rule die cutting, punch press converting, static razor slitting, burst knife slitting, water jet cutting, matched-metal punching, shear slitting, laser cutting, and router cutting. Different converting methods can produce different-sized IES regions, varying edge angles e, and different surface structures than the specific angled striations discussed so far. For example, creating an IES region with a static razor blade produces a “funneling” effect on the launch edge, as is further described herein.

Some converting methods benefit from roughening of the blade surface near the cutting edge to produce adequate surface structure for use as an IES region. Roughening can be accomplished through sandblasting, ion milling, or fine abrasion, for example, although other methods may be used as well. By providing a surface that is roughened on a fine and regular scale, the changes of obtaining a vertical edge angle are improved. Blade surface treatments such as titanium nitride can also provide a rougher surface, and thereby improve the chances of obtaining the desired level of consistent roughness of the input edge structure. Other options for blade treatment include titanium aluminum nitride, zirconium nitride, Tetrabond® coating available from IonBond of Madison Heights, Mich., physical vapor deposition coatings or chemical vapor deposition coatings. Blade wear and handling also impact production of a consistent launch edge. Any defect on the cutting edge of the razor can produce non-uniformities on the cut edge.

Different converting methods can be used for different edges of a film piece. For example, rotary razor blade cutting can be used on the launch edge of a film piece, while die cutting, stamping, punch press die cutting or rotary die cutting can be used on the remaining edges of the film piece.

In some embodiments of the converting method, the web is heated before cutting of the film pieces. Heat may be applied using an infrared heater positioned above the web. The web may be heated to a temperature above the ambient temperature up to about 50 degrees C. above the glass transition temperature for any of the layers of the web, in one embodiment. Where a two-layer flexible light guide structure is used, the top layer often particularly benefits from heating before cutting, as the incidences of chipping of the top layer are reduced.

In some embodiments of the converting method, the web is moved toward a cutting implement while the cutting implement does not move in a linear manner. In other embodiments, the web is stationary and the cutting implement or blade is moved linearly with respect to the web at a first speed.

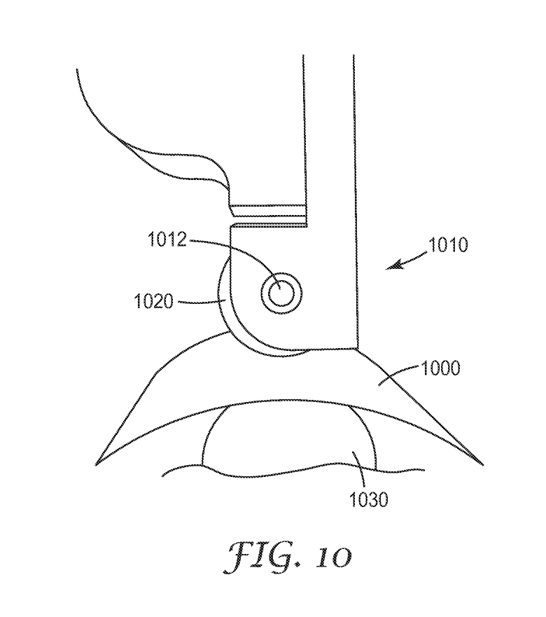

FIG. 10 is a schematic side view of a launch edge and an IES region being produced in a web 1000 of film with a rotary razor blade. The razor blade 1020 is circular and is fixed to a cutting station 1010 through an axis 1012, so that the razor blade can rotate about the axis. The cutting station 1010 additionally has an anvil 1030. The razor blade 1020 is held at a fixed distance from the anvil 1030 so that when the web 1000, which has a liner or carrier layer, is cut, the liner remains intact. The web 1000 can be in reel form. Components of the cutting station 1010 are generally made of material known in the art. For example, the anvil 1030 is known in the art to be constructed of a variety of materials including steel, iron, and so on. The anvil 1030 is cylindrical in one embodiment and rotates about an axis to help guide the web 1000 through the razor blade 1020. In another embodiment the anvil 1030 is stationary.

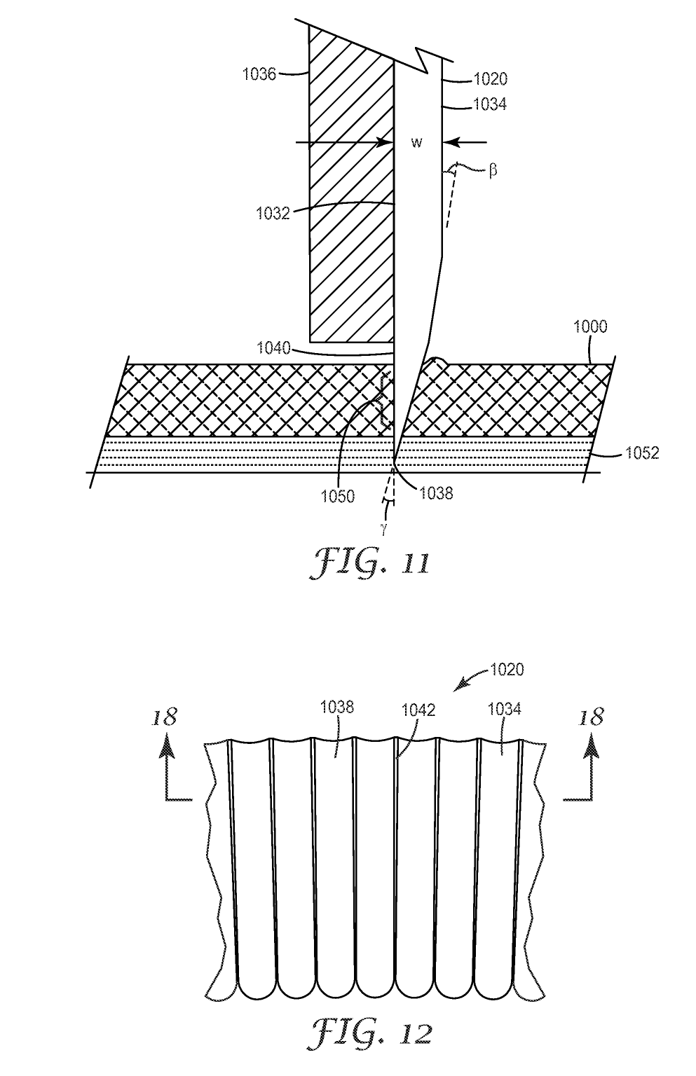

FIG. 11 is a schematic cross-sectional view of the web 1000 being cut in a cutting station 1010 consistent with one embodiment of the technology disclosed herein. The blade 1020 is consistent with a rotary razor blade and defines a thickness w, a grind angle β, and a hone angle γ. In one embodiment, the blade thickness is at least 0.5 mm. In one embodiment the blade thickness is 0.8 mm or less. In one embodiment, the blade thickness is 0.6 mm. The blade is planar on a first side 1032 and is non-planar on a second side 1034, having a chisel profile. The hone angle γ in one embodiment is at least 5 degrees and not more than 45 degrees. In some embodiments, the grind angle β is greater than or identical to the hone angle. One possible range for the grind angle β is at least 5 degrees and not more than 45 degrees. One example of a blade material is stainless steel.

The blade 1020 is supported on its planar side by a blade hub 1036 in this embodiment. Supporting the blade improves the rigidity of the blade during the cutting process.

Roughening methods can be used in region 1040 near the edge 1038 of the blade, such as sand blasting, ion milling, fine abrasion or a coating, for example, but certainly other methods can be used that are known in the art. In one embodiment, a blade that is surface coated with titanium nitride provides a rougher surface on the planar side 1032 of the blade, and thereby improves the chances of obtaining a vertical edge and the desired level of consistent roughness of the input edge structure. The chisel surface 1034 of the blade may be buffed to provide a very smooth surface, in some embodiments, which assists with making sure that the cut material is pushed away from the remainder of the web. The input edge region 1050 is defined on the launch edge of a film piece by the rotary razor blade 1020.

In some embodiments, the blade 1020 also defines a substantially uniform serrated edge 1042, a front view of which is shown in FIG. 12. The edge area 1038 where blade treatments or coatings can be performed overlaps with the serrated edge area 1042. A serrated edge on a rotary razor embodiment can result in wider grooves on the launch edge. A blade can be patterned in some other way also, such as using micro-machined techniques to create grooves and other structures.

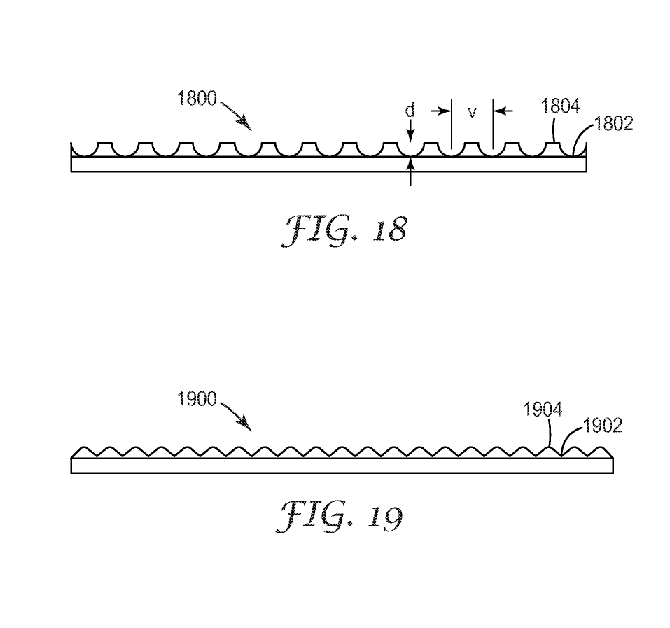

The term “serrated” is intended to mean that there is a repeating pattern of notches or variations in the thickness of the blade at its edge, while the term “serrations” refers to those notches. Examples of serrated edge profiles 1800 and 1900 are illustrated in FIGS. 18 and 19, respectively. FIG. 18 is a cross-sectional view along line 18-18 of FIG. 12. The serration pattern of FIG. 18 includes U-shaped valleys 1802 separated by plateaus 1804. In one embodiment, the blade thickness w is 0.6 mm, the depth d of the valleys 1802 is 0.2 millimeter, and the valley-to-valley v spacing is 0.3 mm.

FIG. 19 illustrates another embodiment of a cross-sectional profile of a serrated blade edge. In FIG. 19, the serration pattern includes V-shaped valleys 1902 separated by peaks 1904. In one embodiment, the blade thickness w is 0.6 mm, the angle defined by the sides of the valley is 90 degrees, the depth d of the valleys 1902 is 0.05 millimeter, the width of the plateaus is 0.02 mm, and the valley-to-valley v spacing is 0.125 mm.

The notches of a serrated blade may also reduce the blade's diameter at the notches, as is true to a small degree in blade 1020 as shown in the front view of FIG. 12. But the terms serrated or serration as used herein do not require such reductions in the diameter.

In some embodiments, the rotary razor blade produced structures that are not grooves, such as bumps or irregular structures. These types of input edge structures can be adequate for improving the coupling of light into the light guide.

The method of converting the web 1000 with a rotary razor blade 1020 will now be explained. The reel of the web of film 1000 is unwound and fed into a rotary razor cutting station 1010. The web 1000 passes over the anvil 1030 and into the razor blade 1020. The liner side of the web 1000 rides against the anvil 1030 and prevents the razor blade 1020 from crashing into the anvil 1030, which could cause defects in the blade 1020. The blade 1020 cuts through the web 1000, leaving the liner 1052, however, to serve as a carrier.

Razor blade geometry and material choices impact and can be used to control the launch edge quality. The blade parameters that can impact the launch edge quality include, but are not limited to: blade material and thickness w, blade and blade edge geometry, edge polishing methods, and blade surface coatings. Such parameters can contribute significantly to edge angle and RMS roughness of a light guide.

An additional parameter related to the rotary razor converting method is whether the rotary razor blade is actively driven to rotate. In one embodiment, the rotary razor blade is configured to freely rotate on its axis but is not actively driven to rotate. In this embodiment, the rotary razor blade will be caused to rotate by the movement of the web relative to the blade. In another embodiment, the rotary razor blade is actively driven to rotate, so that the blade rotates even when not contacting a moving web. If the rotary razor blade is driven to rotate, then the direction of rotation may either be in a first rotation direction or a second opposite rotation direction, and the speed can be varied. Referring to the orientation of FIG. 10, in some embodiments, the side of the rotary blade that is facing the viewer is rotating in a clockwise direction and in some embodiments that side of the blade is rotating in a counter-clockwise direction. The blade speed may vary so that the linear equivalent of the rotation speed is either the same as the web speed, slower than the web speed, or faster than the web speed.

### Static Razor Blade Converting Method

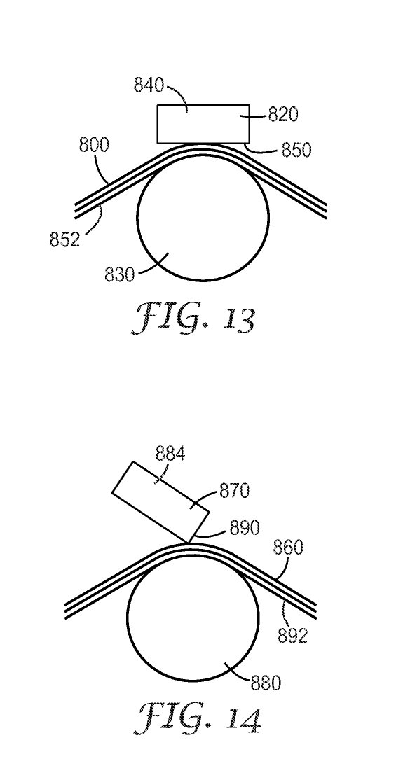

FIG. 13 is a schematic side view of a process step consistent with one embodiment of the technology disclosed herein. In this embodiment a static razor 820 is used to cut the launch edge on a moving web 800, as the moving web 800 passes over an anvil roll 830. The razor 820 is depicted in a first position 840 in FIG. 13 so that the razor flat edge 850 is in contact with the web 800. The web 860 includes a carrier film 852 or liner.

FIG. 14 is a schematic side view of an alternate arrangement for cutting a web 860 with a static razor blade 870. In this embodiment, the static razor 870 is in a second position 884 where the razor corner 890 is used to cut the launch edge on a moving web 860, as the moving web 860 passes over an anvil roll 880. The web 800 includes a carrier film 892 or liner.

For either the arrangement of FIG. 13 or 14, the razor is positioned so that the depth of the razor cut is adjusted to cut through the web itself, but not through the underlying liner that is typically 25 to 50 microns thick. In this manner the light guides may still be carried by the intact liner. The razor 820 may be positioned by a suitable fixture (not shown) to allow adjustment of cut depth and lateral position. Use of the flat edge in the first position 840 may exhibit longer blade life and also allow the blade to be repositioned to use a fresh razor edge when needed. However, flat-edge cutting can produce greater amounts of fine particulate than use of the razor corner 890 in the second position 884.

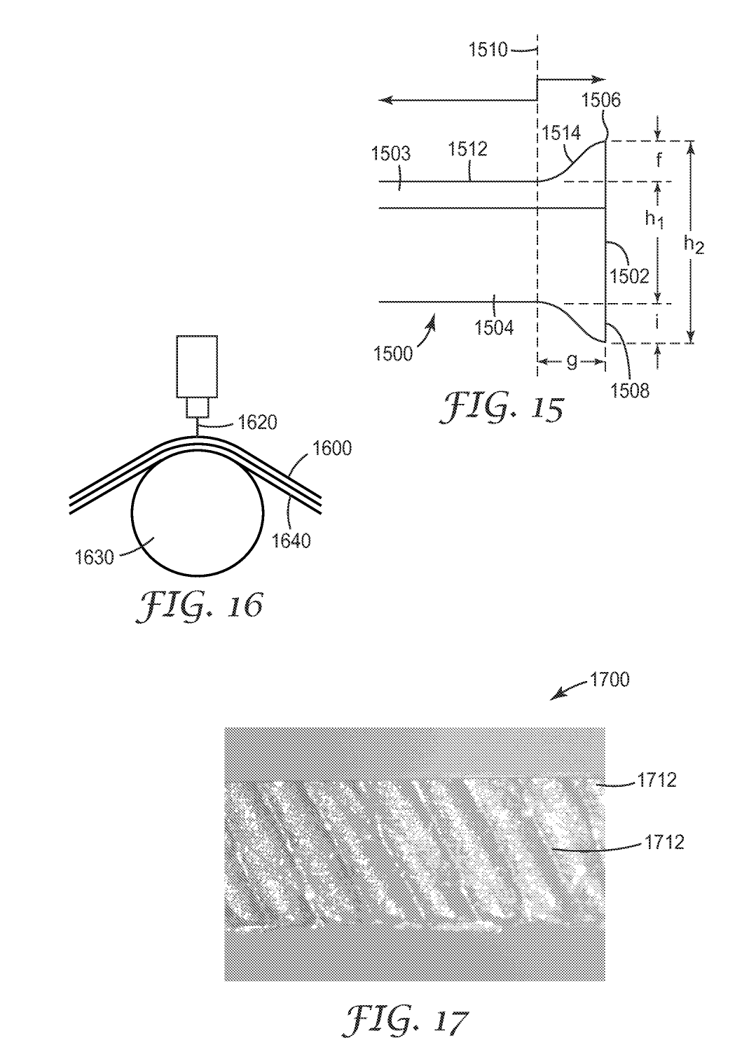

FIG. 15 is a side profile of a light guide 1500 created using a static razor blade method to produce the launch edge 1502 and define structures on the launch edge. The light guide includes first layer 1503 and second layer 1504. The stationary blade causes a slight “funneling” effect that can produce varying thickness adjacent to the launch edge 1502 of the light guide 1500. A top flair region 1506 has a height f and a bottom flair region 1508 has a height i. The width of the flair regions 1506, 1508 is g. Because of the flair regions, the thickness of the light guide varies approaching the launch edge 1502. To the left of a boundary line 1510, a first light guide region 1512 has a thickness that does not vary substantially and is shown as h₁. To the right of the boundary line 1510 and adjacent to the launch edge 1502, a second light guide region 1514 is defined and the thickness of the second light guide regions varies from h₁ to h₂.

The input edge structures typically created by a static razor method have a more horizontal orientation than the input edge structures created by a rotary razor method. For example, the groove angle of an IES formed in a static razor blade method can be at least 85 degrees and not more than 95 degrees.

### Router Converting Method

FIG. 16 is a view of a process step consistent with one embodiment of the technology disclosed herein. In this embodiment a router head 1620 is used to cut the individual film pieces from a web 1600. The router head 1620 is mounted in the path of a web 1600 above a roll anvil 1630. The routing depth is positioned to cut through the entire web 1600, but not completely through an underlying liner 1640. The speed of the web 1600 and the rotation speed of the router 1620 are coordinated to maintain the desired shape of the IES region.

FIG. 17 is a photograph taken through a microscope of one example of an input edge structure resulting from router cutter method. The light guide 1700 includes an IES region 1712 imparted by router cutting of the launch edge 1702, created using the router head attachment with a ZÜND™ Flatbed Cutter, made by Zünd Systemtechnik AG, in Altstätten, Switzerland. The surface qualities of the IES region 1712 are the consequence of the router tool bit shape, the router rotation speed, and the linear speed of the router head.

### Input Edge Coupler Embodiments

In some embodiments, the light guide includes an input edge coupler structure, as described in co-pending, commonly assigned, U.S. Provisional Patent Application No. 61/117,376, titled “Input Edge Coupler,” and filed on Nov. 24, 2008, which is hereby incorporated herein by reference in its entirety.

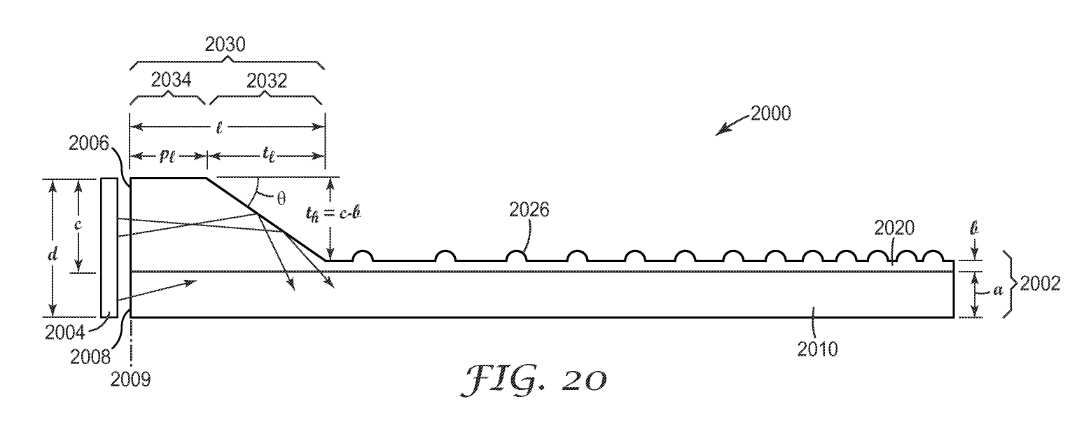

FIG. 20 illustrates a display system 2000 having such a light guide 2002 which includes a substrate 2010 of thickness a, and a first flexible layer 2020 of thickness b. The substrate 2010 may also be referred to as the second flexible layer. The thickness b of first flexible layer 2020 is taken to be the thickness of the “land” of the first flexible layer, which is the portion of the layer excluding protruding structures, such as light extraction features 2026 and input edge coupler 2030.

First flexible layer 2020 integrally includes, disposed along an edge 2009 of the light guide 2002, an input edge coupler 2030 capable of bringing light from the one or more exterior light sources 2004 into propagation within the light guide 2002. The input edge coupler 2030 may include an input edge coupler input edge 2006 having an input edge thickness c disposed along the edge 2009 of the light guide 2002. As illustrated in FIG. 20, the light guide input edge includes both the input edge coupler input edge 2006 and a second flexible layer input edge 2008, both of which are suited to receive light from the external light source 2004. The input edge coupler 2030 may include a taper region 2032, where first flexible layer 2020 tapers in thickness from the thickness c to the first flexible layer land thickness b over a taper region length t₁. In a case where a taper region transitions from a thickness c to the surface of a wedged-shaped layer or substrate, the input edge coupler tapers down in the taper region to the local thickness of the land of the wedge-shaped layer.

The edge 2009 of the light guide 2002 includes one of the varieties of input edge structures described herein to facilitate the coupling of light into the light guide, which may be created by any of the converting methods described herein. The web from which the light guide 2002 is cut can be heated during the cutting operation, to decrease the brittleness of the layers, especially of the first flexible layer, and to thereby decrease the chance of chipping of the light guide.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

What is claimed is:

1. A method of forming a light guide comprising:
providing a web of a film having a major surface and a web edge; and
cutting the web to provide film pieces, wherein each film piece has a first major surface, a second major surface and at least a first cut edge;
wherein the first major surface of each film piece is capable of emitting light when light is injected into the film piece from the first cut edge of the film piece;
wherein the major surface of each film piece is capable of emitting at least a majority of the light injected into the film piece from the first cut edge;
wherein the step of cutting produces structures on the first edge of the film.

2. The method of claim 1 further comprising the step of:
injecting light into the first edge of the light guide.

3. The method of claim 1 wherein the major surface of the film comprises a plurality of light extractors capable of extracting light propagating in the web.

4. The method of claim 1 wherein the web of the film comprises diffuse particles in a gloss-gloss substrate.

5. The method of claim 1 wherein the step of cutting is performed by a cutting tool having a blade.

6. The method of claim 5 wherein the step of cutting is performed by a rotary razor blade.

7. The method of claim 6 wherein the rotary razor blade has a hone angle of at least 5 degrees and not more than 45 degrees.

8. The method of claim 6 wherein the rotary razor blade is asymmetrical, having a planar surface on one side and having a chisel profile on an opposite side.

9. The method of claim 8 wherein the rotary razor blade is supported by a blade hub on the planar side.

10. The method of claim 6 wherein the blade thickness is at least 10 mils and not more than 35 mils.

11. The method of claim 5 further comprising the step of treating the finish of at least a portion of the blade before the step of cutting the web.

12. The method of claim 11 wherein the step of treating includes coating at least a portion of the blade.

13. The method of claim 12 wherein the coating comprises titanium nitride.

14. The method of claim 11 wherein the step of treating includes sandblasting.

15. The method of claim 6 wherein the rotary razor blade comprises serrations.

16. The method of claim 5 wherein the blade comprises stainless steel.

17. The method of claim 1 further comprising the step of heating the web before the step of cutting the film.

18. The method of claim 5 wherein during the step of cutting the web, the blade is driven to rotate.

19. The method of claim 5 wherein during the step of cutting the web, the web is moving at a web speed in a first direction and the blade is not moved with respect to the web.

20. The method of claim 5 wherein during the step of cutting the web, the web is stationary and the blade is moved linearly with respect to the web at a first speed.

21. The method of claim 5 wherein the step of cutting the web using a cutting tool with a blade is carried out on the first edge, further comprising the step of cutting the remaining edges of the film piece by die-cutting.

22. The method of claim 1 wherein an edge angle formed between a mid-section of a surface of the first edge and a first major surface of the film piece is at least 85 degrees and not more than 95 degrees.

23. The method of claim 22 wherein the edge angle is at least 88 degrees and not more than 92 degrees.

24. The method of claim 1 wherein the structures on the first edge of the film are parallel grooves.

25. The method of claim 24 wherein each film piece has a first major surface, wherein a groove angle is defined between the parallel grooves and a normal to the first major surface of the film, wherein the groove angle is at least 2 degrees.

26. The method of claim 25 wherein the groove angle is at least 10 degrees.

27. The method of claim 1 wherein the web of film includes a carrier liner, wherein the step of cutting the web does not comprise cutting the carrier liner into pieces.

28. The method of claim 1 wherein the step of cutting the web comprises cutting at least partially into the carrier liner.

29. A method of forming a light guide comprising:
providing a web of a film having a major surface and a web edge, wherein the major surface of the film comprises a plurality of light extractors capable of extracting light propagating in the web; and
cutting the web using a rotary razor blade to provide film pieces, wherein each film piece has a first major surface, a second major surface and at least a first cut edge;
wherein the first major surface of each film piece is capable of emitting light when light is injected into the film piece from the first cut edge of the film piece;
wherein the major surface of each film piece is capable of emitting at least a majority of the light injected into the film piece from the first cut edge;
wherein the step of cutting produces parallel groove structures on the first edge of the film.

30. An intermediate product formed during the process of forming a light guide comprising:
a web of a film having:
a first major surface,
a second major surface, and
a first edge, wherein the first edge comprises structures,
wherein the first major surface of the light guide is capable of emitting light when light is injected into the first edge of the web, wherein the first major surface is capable of emitting at least a majority of the light injected into the launch edge.

31. The light guide of claim 30 wherein the first major surface further comprises a plurality of light extractors capable of extracting light propagating in the light guide.

32. The light guide of claim 31 wherein the structures on the launch edge surface of the light guide comprise parallel grooves.

33. The intermediate product of claim 31 wherein the web comprises a first flexible layer and a second flexible layer, the light extractors are present in the first flexible layer and are discrete light extractors capable of extracting light propagating in the light guide such that light is extracted uniformly over substantially the entire first major surface of the first light guide.

34. The method of claim 33 wherein the first flexible layer has a substantially flat land area separating the plurality of discrete light extractors, the average thickness of the land area being no greater than 10 microns.

35. The light guide of claim 30 wherein the root mean square roughness of the launch edge surface is less than 10.0 microns.

36. The light guide of claim 35 wherein the root mean square roughness of the launch edge surface is less than 5.0 microns.

37. An intermediate product formed during the process of forming a light guide comprising:
a web of a film comprising a first flexible layer and a second flexible layer, wherein the web further comprises:
a first major surface of the first flexible layer,
a second major surface of the second flexible layer,
a plurality of light extractors capable of extracting light propagating in the light guide on the first major surface, and
a first edge, wherein the first edge comprises structures,
wherein the first major surface of the light guide is capable of emitting light when light is injected into the first edge of the web, wherein the first major surface is capable of emitting at least a majority of the light injected into the launch edge.

38. A light guide comprising:
a first flexible layer having a first major surface;
a second flexible layer having a second major surface;
a launch edge comprising a launch edge surface, wherein the launch edge surface comprises structures,
wherein the first major surface of the light guide is capable of emitting light when light is injected into the light guide from the launch edge, wherein the first major surface is capable of emitting at least a majority of the light injected into the launch edge; and
wherein the light guide includes:
a first region where thickness does not vary substantially, and
a second region adjacent the edge of the light guide where the thickness of the light guide varies at a first rate.

39. The light guide of claim 38 further comprising:
a light source positioned at the launch edge of the light guide.

40. The light guide of claim 38 wherein the first major surface further comprises a plurality of light extractors capable of extracting light propagating in the light guide.

41. The light guide of claim 38 wherein the structures on the launch edge surface of the light guide comprise parallel grooves.

42. The light guide of claim 38 wherein the root mean square roughness of the launch edge surface is less than 10.0 microns.

43. The light guide of claim 38 wherein the root mean square roughness of the launch edge surface is less than 5.0 microns.
